(19) United States
(12) Patent Application Publication
(10) Pub. No.: US 2025/0317101 A1
(43) Pub. Date: Oct. 9, 2025

(54) TRACKING-TYPE SOLAR TROUGH ASSEMBLY

(71) Applicant: Raja Singh Tuli, Montreal (CA)

(72) Inventor: Raja Singh Tuli, Montreal (CA)

(21) Appl. No.: 19/169,398

(22) Filed: Apr. 3, 2025

Related U.S. Application Data
(60) Provisional application No. 63/631,006, filed on Apr. 8, 2024.

(51) Int. Cl. H02S 40/22; H02S 40/30

(52) U.S. Cl. CPC H02S 40/22; H02S 40/30

(57) ABSTRACT

The present invention provides a solar energy harvesting system comprising a plurality of parabolic-shaped trough solar concentrators and solar cells mounted on an assembly. A new solar panel design comprising trough-shaped solar concentrators with mirrors inside a box is disclosed. Unlike typical designs, these mirrors have flat surfaces along the trough, which helps spread out sunlight better and avoid heat concentration on the solar cells. The troughs are connected using folded flaps, keeping the panel light with thin stainless steel. A transparent cover sheet on top protects and supports the troughs. Multiple vertical plates support the structure, connecting the troughs using round protrusions on the troughs. The multiple components within the solar energy system cooperate to continually concentrate the incoming solar radiation on the solar cells as the Sun runs its course across the sky.

### CROSS-REFERENCE TO RELATED APPLICATIONS

This application claims priority to U.S. provisional patent application No. 63/631,006, entitled “TRACKING-TYPE SOLAR TROUGH ASSEMBLY,” filed on Apr. 8, 2024. The content of this U.S. provisional patent application is hereby incorporated by reference in its entirety for all purposes.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present disclosure generally relates to systems that employ energy converting units, such as photovoltaic cells, to harness solar energy. More particularly, the present invention pertains to a solar energy concentrating system where trough-shaped solar concentrators are mounted on an assembly and the whole assembly moves on an axis to track the Sun for achieving maximum solar radiation to the solar cells.

### Description of Related Art

Efforts to save the environment and search for a renewable source of energy have given rise to many advances in solar-electricity generation for both commercial and residential applications. Typically, photovoltaic (PV) solar cells are used in a solar panel to convert sunlight into electricity. When the sun shines onto a solar panel, energy from the sunlight is absorbed by the PV solar cells in the panel. These solar cells are typically made using square or quasi-square silicon wafers that are doped using established semiconductor fabrication techniques and absorb energy from sunlight. This energy creates electrical charges that move in response to an internal electric field in the cell, causing electricity to flow.

Generally, a large number of PV solar panel assemblies are mounted on an open field or on a surface of a building to receive sunlight irradiation and generate the power. In order to make PV modules receive better sunlight, a solar tracking system was implemented in some methods. The motion of the sun can be tracked in real-time, and the orientation of the solar panel is adjusted to receive the sunlight always perpendicular to the solar panel. In this way, the amount of solar radiation received by the solar panel can be maximized and hence the power generated by the solar system.

The typical solar concentrators can be classified according to several aspects. The ones relevant for the purpose of the present description are the kind of focusing employed (point, line or area), positional adjustability of the reflectors involved in the concentration process (fixed or tracking devices) and characteristics of the conversion systems—solar panels, heat absorbers, or both.

Compared to non-concentrating solar energy conversion systems, the sunlight concentrated toward a photovoltaic solar panel is magnified. As a result, on the one hand, solar energy concentrator systems benefit more than non-concentrating solar energy systems from using relatively more performing solar panels. Efficiency improvements are fast in the field of photovoltaic solar cells, and solar energy concentrator systems thus benefit particularly from an easy upgrade to a more efficient solar panel. On the other hand, more heat is gathered at the target area of a concentrator system than in a non-concentrating solar energy system. Heat negatively affects the efficiency of photovoltaic solar panels, entailing that efficient heat transfer or cooling systems have a special importance in solar energy concentrator systems that rely on photovoltaic solar panels as their receivers.

Several examples of solar energy concentrators are found in the prior art. These apparatuses feature several inconveniences, such as complexity and cost. Furthermore, many of those designs do not easily lend themselves to installation in the scale contemplated for supplying a household. For example, the structural weight and design of even a small-sized, movable dish reflector complicates its deployment atop a house roof, in addition to making it vulnerable to wind damage. Sidestepping these problems by reducing the scale of the dish reflector seriously limits the amount of energy this kind of concentrator may yield.

Based on the end application, different types of solar concentrators are employed to achieve optimum results. In the specific scope of the present invention—continual collection of concentrated solar radiation reflected to a focal area in order to generate energy for supplying a standard household or small real estate unit—the performance of state of the art solar concentrators is suboptimal, or the system is too expensive or complex for use by a standard household or in a small real estate unit.

In methods described in U.S. Pat. No. 6,971,756 B2 and U.S. patent application No. 20030137754 A1, the concentrator have an array of slat-like concave reflective elements and an elongated receiver for receiving the concentrated sunlight. The mirrored surfaces of reflective elements provides individual profiles represented by curved and/or straight lines are positioned so that the energy portions reflected from individual surfaces are directed, focused, and superimposed on one another to cooperatively form a common focal region on the receiver. The mirrored surfaces are inclined towards one another at their rear ends facing the receiver and can be arranged to provide lens-like operation of the array. The receiver can be arranged in line photovoltaic cells or a tubular solar heat absorber. However, the structure of the concentrator is very big for practical implementation and any change in profile of a single reflective surface could imbalance the whole concentrator arrangement or reduce the efficiency significantly.

Some of the other systems use segmented mirrors like solar concentrators or parabolic trough-shaped structures concentrators for concentrating the sunlight on a pipe. The pipe carries the water to heat and consequently generates the steam to run a turbine for generating electricity. However, in such systems, the collected energy could radiate during the night and the system could not preserve the energy collected during the daytime.

Another alternate method in the prior art uses parabolic mirrors to focus solar rays around a vacuum tube carrying a fluid or material for heating and storing energy. However, this method is inefficient in storing heat energy for a longer period of time because the heat could radiate in all directions during the night time.

All these above-mentioned existing approaches do not take into account the size and efficiency of the solar power generation system to collect solar power and generate electricity through different methods.

There is accordingly a need for an improved solar concentrating system that overcomes the limitations associated with using complex or suboptimal structures or assemblies that require a high degree of skills. Moreover, there is a need for an efficient solar concentrating system wherein the costs associated with manufacture and deployment, which are prohibitive with respect to traditional solar concentrating systems, are minimized so that it is affordable and attractive for use by small- and medium-scale household use.

Therefore, the present invention provides a solar tracking system for translating the alignment of collectors in an instrument to track the Sun by rotating the full assembly. The objective of the present invention to disclose a small- or medium-scale, dimensionally-adaptable solar concentrator system featuring high energy conversion efficiency, providing area focus with low building and operational costs.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The invention relates to a solar energy harvesting system comprising a plurality of trough-shaped solar concentrators and solar cells mounted on an assembly. The system comprises a plurality of solar panels mounted on the assembly that tracks the movement of the sun for receiving and concentrating maximum solar radiation.

In a preferred embodiment of the present invention, solar panels are mounted on a Sun tracking assembly tracking the Sun using a motor. Each panel comprises one or more trough-shaped solar concentrators each consisting of two parabolic mirrors. The parabolic mirrors reflect incident sunlight onto the solar cells. In a preferred embodiment, one or more trough-shaped concentrators and mirrors are arranged so that the sunlight is evenly incident on the solar cell. Further, a top cover sheet, preferably made of a transparent material such as glass, is attached to the top of the panel.

The innovation relates to a solar panel configuration incorporating trough-shaped concentrators housing parabolic mirrors within a box structure. Diverging from the conventional perfect parabolic surface, the mirrors exhibit three to four flat surfaces along the trough, enhancing the distribution of solar rays and reducing hotspots on solar cells. Troughs are interconnected using folded flaps, maintaining a lightweight design through the use of thin stainless steel. Structural support and protection are provided by a transparent cover sheet affixed to the top edge of the troughs. Vertical plates support both the troughs and the solar panel, featuring round protrusions aligned with holes on trough flaps for secure connections. This design improves overall efficiency by addressing concentration-related issues and optimizing the utilization of solar energy.

In another embodiment of the invention, an assembly of the Sun tracking system comprises multiple solar panels mounted onto it and the assembly is mounted on a pole. A motorized means attached to the assembly controls the motion of the assembly while tracking the daily motion of the Sun.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a perspective view of a solar panel in accordance with the subject disclosure.

FIG. 2 is another perspective view of a solar panel in accordance with the subject disclosure.

FIGS. 3A-3C illustrate multiple perspective views of a parabolic-shaped solar trough in accordance with the subject disclosure.

FIGS. 4A-4B illustrate two perspective views of a vertical support plate in accordance with the subject disclosure.

FIG. 5 illustrates the construction of a solar panel comprising parabolic-shaped solar troughs and vertical support plates in accordance with the subject disclosure.

FIGS. 6A-6B illustrate the construction of a parabolic-shaped solar trough in accordance with the subject disclosure.

FIG. 7 is the schematic diagrams of a Sun tracking system in accordance with the subject disclosure.

FIGS. 8A-8B are the schematic diagrams of soler cell protection layers in accordance with the subject disclosure.

FIGS. 9A-9B are the schematic diagrams of soler cell designs in accordance with the subject disclosure.

### DETAILED DESCRIPTION

The subject disclosure is directed to a solar energy concentrating system where trough-shaped solar concentrators are mounted on an assembly and the whole assembly moves on an axis to track the Sun for achieving maximum solar radiation to the solar cells. Additionally, glass is provided to cover the solar concentrator assembly, and vertical metal plates hold the trough-shaped solar concentrators, providing structural support.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The invention is a solar energy concentrating system comprising plurality of trough-shaped solar concentrators mounted on an assembly. The solar concentrator assembly moves on an axis to track the Sun to achieve maximum solar radiation to the solar cells. Furthermore, glass covers the solar concentrator assembly, and vertical metal plates hold the trough-shaped solar concentrators, providing structural support.

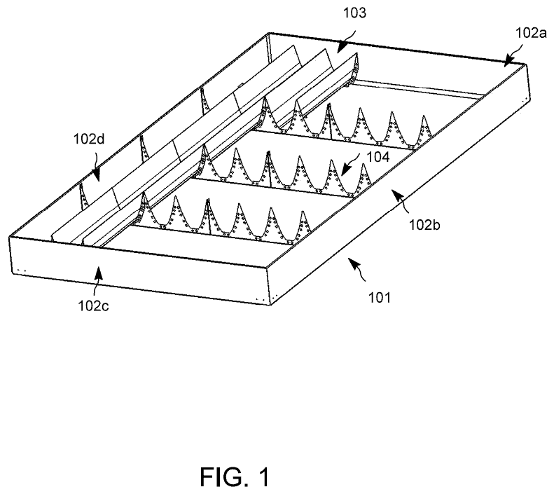

Now referring to the drawings and particularly to FIG. 1 to FIG. 7, various features of the subject disclosure are now described in more detail with respect to a solar concentration system.

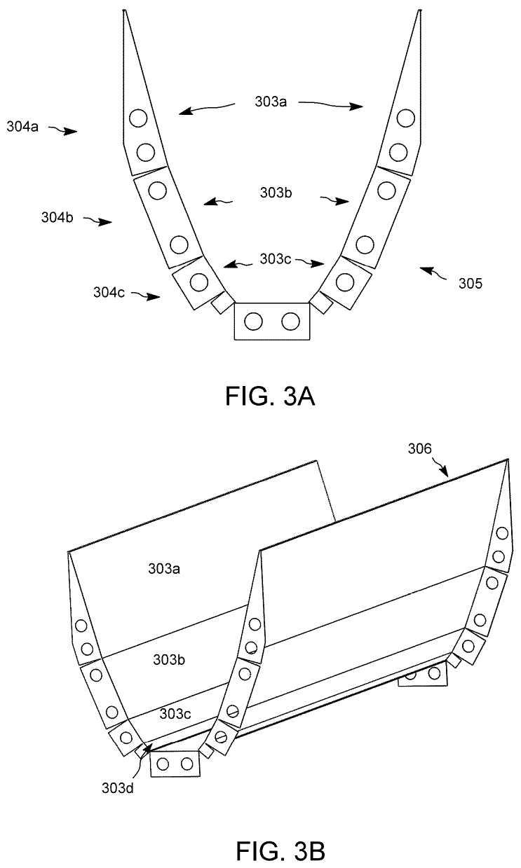

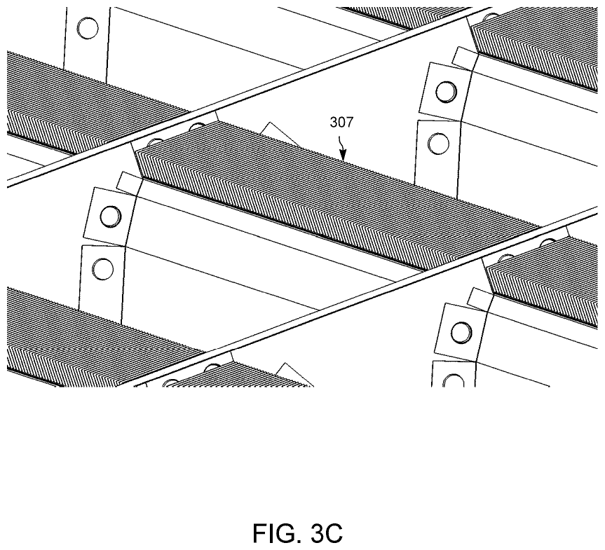

FIG. 1 illustrates a solar panel 101 for concentrating the solar rays on solar cells. The solar panel 101 comprises a plurality of trough-shaped solar concentrators 103. Each individual trough consists of two parabolic-shaped mirrors, labelled as 103a and 103b, positioned with their reflecting surfaces oriented toward each other (comprehensively described in FIG. 3A). As illustrated, four side walls 102a-d, collectively forming a boxed-shaped framework, define the structural configuration of the solar panel 101. The opposing side walls, specifically 102a and 102c, are configured to accommodate and support the troughs 103 at their respective ends. A plurality of vertical plates 104 can provide support to the troughs in between. In a preferred embodiment of the invention, the parabolic-shaped mirrors 103a and 103b may be designed to feature three to four flat surfaces along the trough, deviating from the conventional perfect parabolic surface. The flat surfaces help in evenly distributing the solar rays to the solar cells and reduce the hot concentration points on the solar cells. Consequently, the new solar trough design increases the overall efficiency of the solar concentrator. In an alternate embodiment of the invention, the three to four flat surfaces along the troughs can be slightly curved. The alternate curved design ensures evenly focusing the solar rays on the solar cells, further optimizing the performance of the solar concentrator.

In an example embodiment of the invention, the solar panel 101 may have a length of 6 feet comprising three troughs 103 of 2 feet in length, arranged in a row. In order to connect these troughs, the edges of the troughs are folded at 90 degrees angle, creating flaps (described in detail in FIG. 3A). The adjacent troughs can be connected using the flaps. The other ends of the troughs can be connected to the side walls through flaps. For the purpose of maintaining a lightweight and cost-effective panel, the troughs are constructed using a thin and lightweight stainless steel sheet. One or more vertical plates 104 can be introduced at the place of joint of two troughs to provide additional support. The opposite end of the plates 104 are connected to the solar panel side walls 102b and 102d.

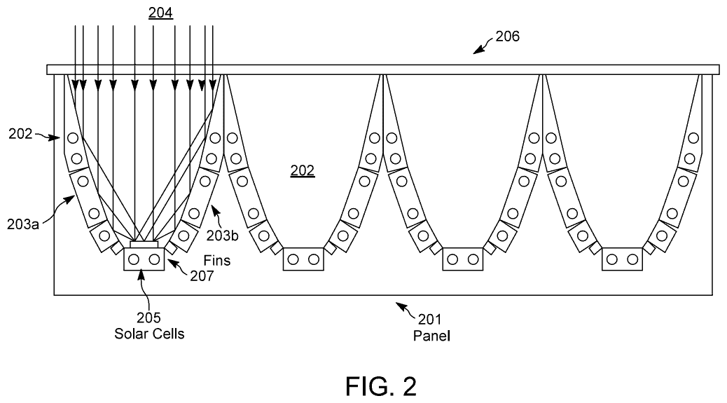

According to a preferred embodiment, as illustrated in FIG. 2, a solar panel 201 comprises multiple troughs. The parabolic-shaped mirrors 203a and 203b of the trough 202 reflect incident sunlight 204 onto solar cells 205. In a preferred embodiment, mirrors 203a and 203b of the one or more trough-shaped concentrators 203 are arranged such that the sunlight 204 is evenly incident on the solar cell 205. Typically, solar cell wafers are of dimensions 1 foot by 1 foot. Solar cell wafers are divided into 12 equal sizes pieces, each measuring 1 inch in width, allowing to incorporate 2 solar cell pieces per trough. The interior surfaces of the stainless steel trough are coated with aluminum or other alternative methods or materials known in the art to provide a reflective mirror finish.

In a preferred embodiment of the invention, the top edge of the trough (stainless steel sheet) is bent to affix a protective transparent cover sheet 206. The protective transparent cover sheet 206 not only protects the solar cells and parabolic mirrors from dust, smoke etc. but also provides structural support to the solar panel 201. In one embodiment, the transparent cover sheet 206 is attached to troughs with adhesive. The transparent cover sheet 206 provides structural strength and protects the solar panel and troughs from bending. In a preferred embodiment of the invention, the protective cover sheet 206 is made of a transparent material such as glass. As illustrated in FIG. 2, a slight gap is intentionally maintained between the trough walls and the solar cells, allowing space for the tabs on the edges of the solar cells, which carry current. In some embodiments of the invention, the troughs may comprise fins 207 on the underside of the troughs below the solar cells 205 to dissipate excess heat. Further, the upper edges of the troughs are meticulously folded, resulting in the creation of narrow lips denoted as 208. The small lips 208 function to maintain the straightness of the trough. In an example embodiment, the lips 208 can be 1 mm in width as compared to the total width of 100 mm of the trough 202. Given that the troughs are fabricated from thin metal sheets, the lips 208 can provide essential structural reinforcement to the troughs themselves, as well as the mirrors 203a-b and the solar panel 201. However, it's important to note that there may be a potential efficiency trade-off associated with the presence of the lips 208 on both sides of each trough 202. Specifically, the inclusion of lips on both sides of each trough may lead to a nominal 2% efficiency loss. This loss may stem from the altered the trajectory of the reflected sunlight. The efficiency loss can be minimized by strategically arranging the troughs in a manner that the lips overlap when placed next to each other. Additionally, overlapping lip arrangement optimizes the structural integrity of the system while maximizing its performance.

It should be understood that the troughs are parabolic-shaped, not the perfect parabolic. In a preferred embodiment of the invention, the parabolic-shaped troughs are manufactured by folding a flat stainless steel sheet at one or more angles, creating a plurality of tabs along the trough. As illustrated in FIG. 3A, there are pairs of tabs 303a, 303b, 303c and 303d on both sides of the troughs. In a preferred embodiment of the invention, the tabs on the troughs are flat as compared to the conventional curved surface. The flat tabs can evenly distribute the solar rays across the solar cells without creating hotspots on the solar cells and minimize the efficiency losses. Even the smallest tabs 303d on both sides of the solar cells can reflect and focus light on the solar cells and reduce the loss as compared to the conventional parabolic shape. In an alternate embodiment of the invention, the three to four flat surfaces along the troughs can be slightly curved to focus the solar cells evenly on the solar cells. In a preferred embodiment, the edges of the troughs are folded at 90 degrees to create flaps 304a-c. One or more holes 305 are provided on each flap to connect troughs to each other, to connect troughs to the vertical metal support plate and/or to connect troughs to the side walls of the solar panel.

FIG. 3B illustrates a lateral perspective view of the through according to an exemplary embodiment. Four tabs 303a-d of the parabolic-shaped trough can be seen in the structure. The top edges of the trough are folded to create a small lip 306. The small lip 306 functions to maintain the straightness of the trough.

FIG. 3C illustrates an inverted perspective view of a trough, showing a heat sink situated on the bottom of the trough beneath the solar cells. In some embodiments of the invention, the heat sink may comprise a metal plate to absorb heat from the solar cells and transfer it to the fins 307. Fins 307 can dissipate the extra heat absorbed by the solar cells by passing the air over the fins.

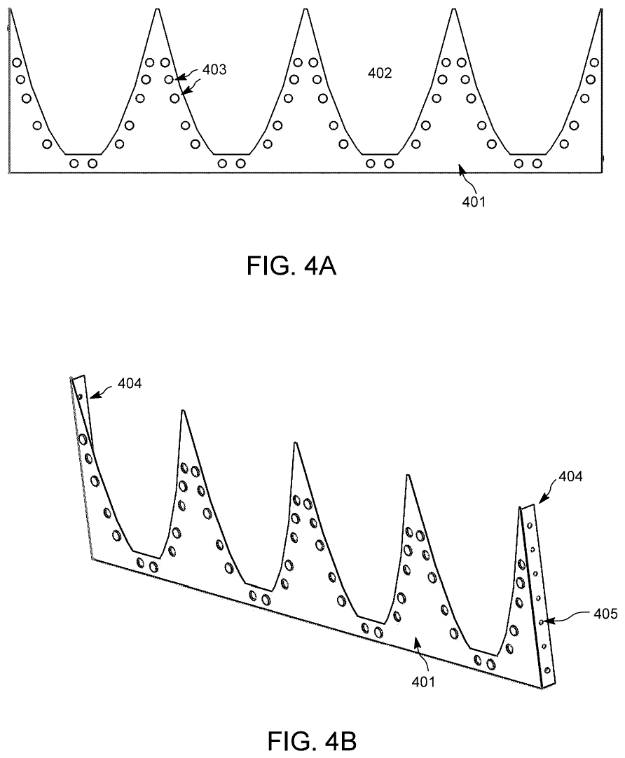

According to a preferred embodiment, the solar panel comprises one or more flat thin metal plates orthogonal to the troughs. FIGS. 4A and 4B illustrate the design of the vertical plate 401, according to a preferred embodiment of the invention. The metal plate 401 may be precisely cut to form one or more openings 402 resembling the shapes of the troughs. The metal plates 401 provide structural support to the troughs and as well as the solar panel. The metal plate 401 serves a dual function, it provides structural integrity while facilitating alignment between the opposing faces of the troughs. The metal plate 401 is provided with strategically positioned holes and protrusions intended to securely fasten and align the troughs, thereby ensuring accurate positioning. Since the troughs are reinforced from thin metal sheet and are flexible in nature, the vertical metal plate not only reinforces strength of the troughs but also ensures precise alignment.

As depicted in FIGS. 4A and 4B, the supporting metal plates 401 may comprise round protrusions 403 on both sides to maintain the shape and strength of the plate. The round protrusions 403 are formed on the vertical plate 401 in such a manner that the protrusions 403 are perfectly aligned with the holes on the trough flaps. In a preferred embodiment, the vertical plate 401 can be attached to the troughs' flaps using a snap fit mechanism. Furthermore, both ends of the vertical plate 401 may be folded to create flaps 404. The flaps 404, equipped with holes 405, enable the connection of the vertical plate 401 to the side walls of the solar panel.

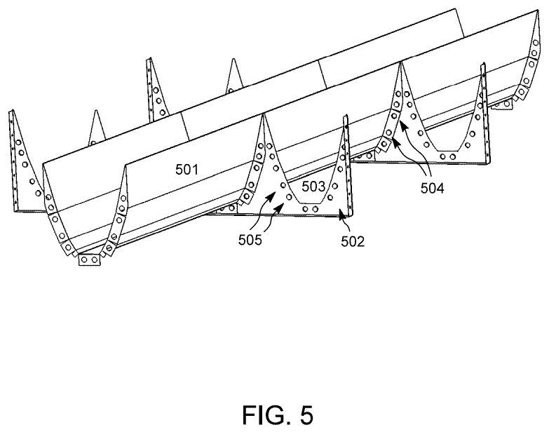

FIG. 5 illustrates a schematic view of connecting one or more troughs 501 to one or more vertical support plates 502. According to a preferred embodiment of the invention, as shown in FIG. 5, a solar panel may comprise multiple troughs. According to an embodiment of the invention, the solar panel is preferably 6 feet long and each trough is 2 feet in length. Consequently, each panel comprises three troughs arranged along the length. As illustrated, the troughs can rest within the gap 503 created on the vertical plates 502. The troughs 501 are attached to the vertical plates 502 with the perfectly aligned holes 504 on the trough flaps and protrusions 505 on the vertical plate with a snap-fit mechanism.

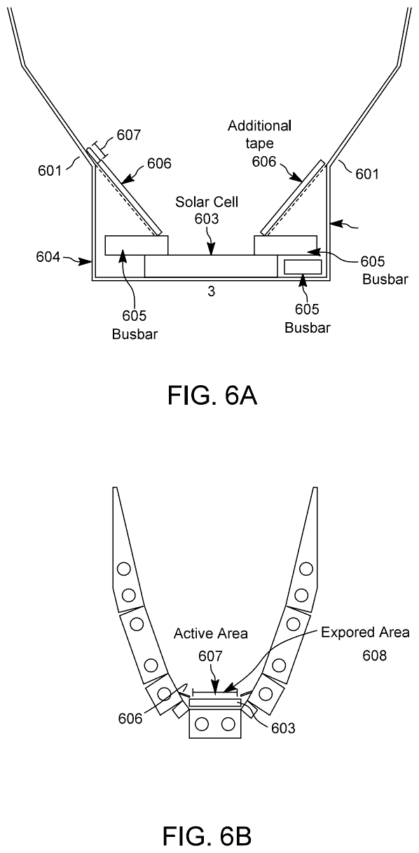

FIG. 6 illustrates a schematic diagram of an arrangement of solar cells on a parabolic trough in accordance with the preferred embodiments of the invention. As explained earlier, the parabolic-shaped troughs are made with a single piece of thin stainless-steel sheet. Solar cells 603 can be placed at the bottom of troughs 601 to receive the solar light reflected by the parabolic-shaped trough mirrors. In a preferred embodiment, a slot 604 can be introduced along the lower edges of the parabolic-shaped trough to accommodate solar cells 603, busbars 605, and wirings. To increase the efficiency of the solar panel, lower edges 601 of the parabolic trough 600 should come to an end at the edges of the solar cell 603 and create a seamless slot 604. The busbars and wiring can be provided in the space between the solar cells and the trough walls on the sides of the solar cells. The busbars and wiring carry the current generated by the solar cells. While the slot 604 can accommodate the solar cell 603, one or more busbars 605, and wirings, creating the slot may encounter efficiency losses attributed to the gap between the solar cells and the reflective trough wall.

As illustrated in FIG. 6A, a method to resolve the aforementioned issue and increase the efficiency of the solar panel, is explained. According to a preferred embodiment of the invention, a reflective tape 606 can be applied on both edges of the trough, covering the space accommodating the busbars and wiring between the solar cell and the trough. The reflective tape 606 can reflect the light from the busbar area to the solar cells. The reflective tape 606 sticks on the edges of the metal solar troughs to create an overlap between the trough and the tape. The application of the reflective tape may occur post-installation of the solar cells, busbars, and wirings. In some embodiments, the tape 606 can be a plastic piece reflecting light on the solar cell. In an additional embodiment, a support mechanism can be provided underneath the reflective tape or reflective plastic piece to enhance structural strength. In some embodiments, the reflective plastic piece along the lower edges of the trough mirrors can provide better overall parabolic shape to the trough as compared to the reflective tape. The proposed arrangement can significantly increase the efficiency of the solar panel.

Ideally, solar panels should be oriented toward the Sun in such a manner that allows incident solar light to be distributed evenly on the entire surface of the solar cell upon reflection from the parabolic-shaped trough mirrors. However, operational discrepancies, such as those induced by motors, may introduce errors in the alignment of large panels with the sun, leading to potential significant losses in solar energy. Even a small deviation, such as a 1-degree error in the solar panel alignment, can result in substantial energy loss. Therefore, instead of designing the troughs to focus the solar light on the entire surface of the solar cells, the troughs are designed to focus the solar light on a narrower area of the solar cell.

An active area can be defined as a narrower area than the entire surface of the solar cell which can capture the solar light and convert it to electrical energy and generate current. An exposed area 608 can be defined as the area on the solar cell visible to a person in an orthogonal direction of the solar trough. As illustrated in FIG. 6B, the active area 607 is generally wider than the exposed area 608. The active area can sense solar light wider than what it is designed for. In a specific embodiment, the solar cell measures 20 mm in width, the trough is designed in configured to concentrate all light onto an 18 mm area, leaving 1 mm on both sides of the solar cell 603.

In the case of an error in the positioning of the solar panel, the solar light can still be captured by one of the sides of the solar cell. As illustrated in FIG. 6B, despite partial coverage by side tapes 606, the active area can extend beyond the exposed area on the solar cell 603. Therefore, the improved trough design with a narrower active area can account for the error of positioning of the solar panels.

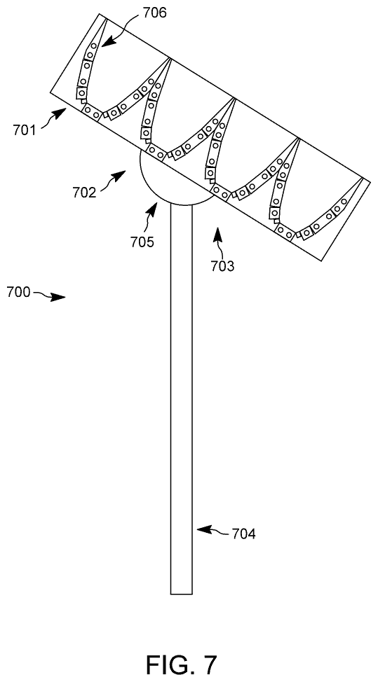

FIG. 7 illustrates a diagram of a solar energy system 700. The preferred embodiment of the present invention comprises a solar panel 701 mounted on a Sun tracking system 702. The sun tracking system 702 comprises an assembly 703 mounted on poles 704 and a motorized drive system 705. In an example embodiment, the assembly 603 has a plurality of solar panels 701 mounted to the assembly 703. Each solar panel 701 of the sun tracking system 701 comprises a plurality of trough-type solar concentrators 706.

In a preferred embodiment, the assembly 703 is connected to an electro-mechanically associated controller and motorized drive system 705 which provides controlled rotation to the assembly 703 and supporting assembly structures to track the daily motion of the sun. The motorized drive system 705 is programmed to turn and orient the assembly 703 in such a way that it follows the sun throughout the day.

In a preferred embodiment, the trough-type solar concentrators 706 on the solar panel 701 are aligned north to south direction and the assembly 703 rotates on a single axis from east to west such that the trough-type solar concentrators 706 always face the sun. In another embodiment, as described in FIG. 7, the assembly 703 can rotate on its axis with the help of motorized means 705.

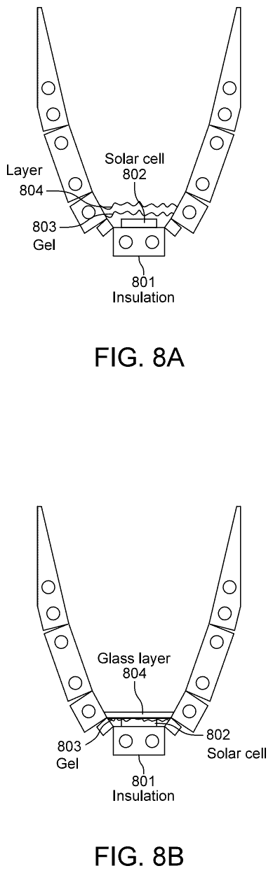

FIGS. 8A and 8B illustrate the intricacies of a solar trough incorporating solar cells, according to a preferred embodiment of the invention. Referring to FIG. 8A, the solar cell 802 is positioned atop a thermal conductivity layer 801. The thermal conductivity layer 801 enhances thermal conductivity, facilitating heat dissipation through the metal structure and the underlying heat sink beneath the trough. A transparent gel layer 803 is applied over the solar cells to serve multiple functions. Primarily, the transparent gel layer 803 ensures safety by mitigating potential hazards associated with high voltages, thus minimizing the risk of sparks and similar incidents. Additionally, the gel layer 803 provides protection to the solar cells against environmental factors such as moisture damage and dust accumulation etc. However, the gel layer 803 may introduce a drawback in the form of light reflection loss from its surface. To address this issue, an additional layer 804 with a refractive index matching material that of the gel layer 803 can be placed atop. The upper (top) layer 804 mitigates losses attributed to light reflection, potentially reducing additional reflection losses by up to 5%. The improvement is achieved by ensuring a matching refractive index, thereby minimizing reflection from the surface of the gel layer 803.

In an alternate embodiment, the top layer 804 can be substituted with a thin glass layer. The thin glass on the top layer 804 can have a matching refractive index of the gel layer 803. Furthermore, the glass on the top layer 804 can also be coated with a material to reduce glass reflection and improve efficiency.

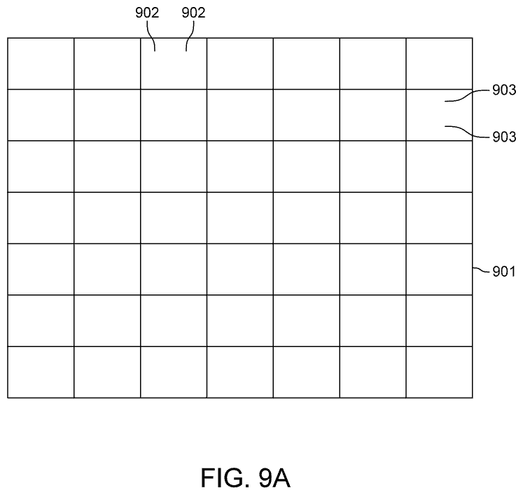

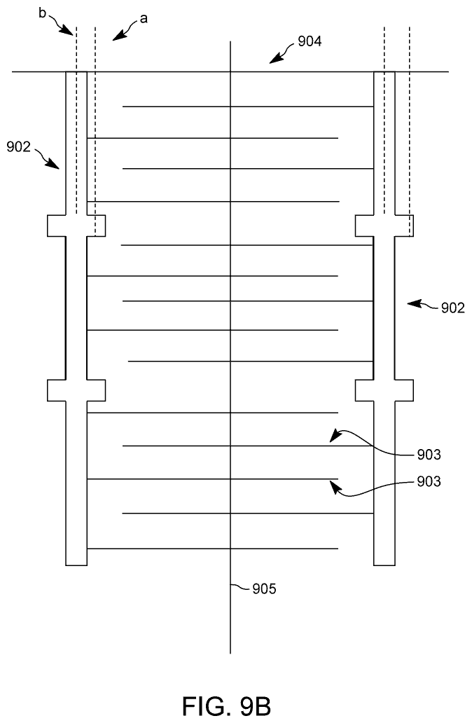

FIG. 9A illustrates a conventional solar cell 901. The most common solar cells are made of silicon wafers and solar conductors on the top to conduct the electrons. As shown in FIG. 9A, the silicon solar cells are metalized with thin rectangular-shaped lines 902 called busbars printed on the front and back sides of the solar cell 901. The busbars 902 conduct the direct current generated by the solar cells to other extremes. Typically, the busbars are constructed from copper, coated with silver. In a typical solar cell, multiple metallic and thinner grid lines are called solar cell fingers 903. The solar cell fingers 903 are perpendicular to the busbars 902. The solar cell fingers collect the generated current for delivery to the busbars. The busbars 902 carry the current generated by the cell fingers 903 to the end and are joined together to one or more electrodes. On the back side of solar cells, additional busbars carrying the opposite current form a positive-negative arrangement for the current supply.

While using conventional solar cells to collect concentrated solar light, the current produced by the solar cells is very high. The busbars and cell fingers in a conventional solar cell are not designed to carry the current generated by the concentrated solar light. Therefore, due to high resistance, the current loss from the busbars and cell fingers in a conventional solar cell is significant.

In certain embodiments, when the busbars are not strong enough to carry the current, additional conductors can be utilized on the busbars. These additional conductors can be connected to the busbars through multiple connections in certain embodiments. In another embodiment, the thickness of the busbars can also be increased through silk-screen printing, epoxy coding, and metallization on top of the existing busbars. Typically, busbars in solar cells are extremely thin, and when the solar cells are cut down the center for dual-sided usage, it is preferable for the cut to align with the center of the busbar. However, due to the thinness of the busbars, there is a risk of either detaching the busbar from the solar cell during cutting or damaging the solar cell itself, resulting in effective functionality only on one side. According to an embodiment of the invention, silk-screen printing can be used to provide an additional busbar onto the solar cell and ensure contact. In an alternate embodiment, a slightly wider busbar can be created atop the existing one through metal deposition or other metallization techniques, as the original busbar may lack the capacity to handle the load. Subsequently, a thicker metallic busbar can be attached to each side to efficiently conduct the current. In some embodiments, additional conductors are connected to the busbars using multiple connections between busbars and conductors through various methods like continuous or scattered connections. The additional conductors on both sides of the solar cell strip can carry the current to the electrodes.

In an embodiment of the invention shown in FIG. 9B, a solar cell is cut vertically into or produced in smaller solar strips 904. The busbars 902, cell fingers 903 and cut lines ‘a’ and ‘b’ are shown in FIG. 9B. In a preferred embodiment of the invention, the solar cells are cut at ‘a’ so that there are busbars carrying the current on both sides of the solar cells. In an alternate embodiment, the solar cells can be cut at ‘b’ on the centre of the busbars in such a manner that the current from alternating cell fingers 903 is transferred through opposing busbars and minimize the current loss on the cell fingers.

Despite the busbars being capable of handling a substantial current load with help of supplementary conductors, the cell fingers 903 may still exhibit high resistance. Moreover, it is not feasible to install busbars atop each finger individually. To address this challenge, an additional cut 905 can be introduced, halving the solar cells. This enables to create busbars on both sides of the fingers, and thereby reducing the distance current must traverse from the edge to reach the busbar by half. This way resistance can be minimized and efficiency can be optimized for the transmission of current generated by the solar cells.

In the preferred embodiment of the invention, regular solar cells can be utilized to create high efficiency solar cells for generating current through concentrated solar light. Further, the high efficiency solar cells can be created by cutting the regular solar cells into strips in the very specific way described supra. The high efficiency solar cells created utilizing the aforementioned method are used in solar panel 101 described in the primary embodiment of the invention.

The detailed description provided above in connection with the appended drawings is intended as a description of examples and is not intended to represent the only forms in which the present examples can be constructed or utilized. It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed. Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

According to an aspect of the present disclosure, a system for collecting and converting solar energy is provided, which comprises: a solar panel comprising a plurality of troughs arranged in one or more rows and aligned with each other, wherein each row contains one or more troughs; one or more solar cells; a protective transparent cover on top; a transverse piece that aligns the edges of the troughs and provides structural strength.

According to an embodiment, the alignment support mechanism is made of metallic plate.

According to an embodiment, the protective transparent cover and the orthogonal metallic plate provide the structural support to the panel.

According to an embodiment, the protective transparent cover is made with glass.

According to another aspect of the present disclosure, a system for collecting and converting solar energy is provided, which comprises: one or more parabolic-shaped troughs, wherein a lower portion of the parabolic-shaped trough is designed to create a gap to facilitate the installation of the solar cells, busbars and wirings; and one or more additional reflective pieces on the edges of the parabolic-shaped trough to cover the gap and provide the reflection of the light towards the solar cell to improve efficiency.

According to an embodiment, additional reflective piece can be a reflective tape.

According to an embodiment, additional reflective piece can be a reflective plastic sheet.

According to an embodiment, additional reflective piece has a support mechanism to maintain the appropriate shape to maximize efficiency.

According to a further aspect of the present disclosure, a parabolic shaped solar tough is provided, which comprises: one or more solar cells; one or more reflective elements configured in a trough shape to concentrate solar light onto the said solar cells. Upper edges of the troughs are bent to create a narrow lip, and the narrow lip serves to provide structural strength and maintain straightness to the parabolic shaped solar trough.

According to an aspect of the present disclosure, a system for collecting and converting solar energy is provided, which comprises: one or more parabolic shaped solar trough fabricated from a single sheet of thin metal; and an orthogonal metal plate featuring cutouts designed for the troughs to fit in and align, wherein a plurality of troughs are interconnected and aligned with the orthogonal metal plate. The orthogonal metal plate serves to provide structural support and strength to the troughs.

According to another aspect of the present disclosure, a system for collecting and converting solar energy is provided, which comprises: one or more parabolic-shaped troughs, wherein a lower portion of the parabolic-shaped trough is designed to create a gap to facilitate the installation of the solar cells, busbars and wirings; and one or more additional reflective pieces on the edges of the parabolic-shaped trough to cover the gap over the busbar and solar cells and directs further light to the solar cell.

According to an embodiment, a support mechanism underneath the reflective piece can serve to enhance structural strength.

According to a further aspect of the present disclosure, a solar cell for collecting solar energy is provided, which comprises: an active area, defined as a narrower region than the entire surface of the solar cell, capable of capturing solar light and converting it into electrical energy to generate current; an exposed area, defined as the portion of the solar cell visible to an observer in an orthogonal direction of a solar panel. The active area is generally wider than the exposed area, enabling the active area to detect solar light broader than its designated coverage; and solar light can be captured by one of the sides of the solar cell, with the active area extending beyond the exposed area, even in the event of an error in the positioning angle of the solar panel.

According to an aspect of the present disclosure, a method for fabricating durable solar cells is provided, which comprises: cutting a solar cell with thin busbars along its centerline to enable dual-sided utilization; printing an additional busbar onto the solar cell surface to ensure continuous electrical contact, wherein said additional busbar is aligned with the centerline cut; depositing a wider busbar atop the existing one through metal deposition techniques to increase load-carrying capacity; and attaching thicker metallic busbars to each side of the solar cell to facilitate efficient current conduction.

According to an embodiment, the printing of the additional busbar is performed using a silk-screen printing technique.

According to another aspect of the present disclosure, a system for collecting and converting solar energy is provided, which comprises: a solar panel comprising a plurality of troughs arranged in one or more rows, wherein each row contains one or more troughs; one or more solar cells; wherein the solar cells are covered with a transparent gel layer to protect the solar cells; and an additional layer over the transparent gel layer to reduce the reflection effect; wherein the additional layer has the refractive index matching to the transparent gel layer.

According to an embodiment, the additional protective layer is made with a material matching the refractive index of the gel layer.

According to an embodiment, the additional protective layer is made with a thin glass matching the refractive index of the gel layer.

What is claimed is:

1. A system for collecting and converting solar energy, comprising:
a solar panel comprising a plurality of troughs arranged in one or more rows and aligned with each other, wherein each row contains one or more troughs;
one or more solar cells;
a protective transparent cover on top;
a transverse piece that aligns the edges of the troughs and provides structural strength.

2. The system according to claim 1, wherein the alignment support mechanism is made of metallic plate.

3. The system according to claim 1, wherein the protective transparent cover and the orthogonal metallic plate provide the structural support to the panel.

4. The system according to claim 1, wherein the protective transparent cover is made with glass.

5. A system for collecting and converting solar energy, comprising:
one or more parabolic-shaped troughs, wherein a lower portion of the parabolic-shaped trough is designed to create a gap to facilitate the installation of the solar cells, busbars and wirings, and
one or more additional reflective pieces on the edges of the parabolic-shaped trough to cover the gap and provide the reflection of the light towards the solar cell to improve efficiency.

6. The system of claim 5, wherein additional reflective piece can be a reflective tape.

7. The system of claim 5, wherein additional reflective piece can be a reflective plastic sheet.

8. The system of claim 5, wherein additional reflective piece has a support mechanism to maintain the appropriate shape to maximize efficiency.

9. A solar cell for collecting solar energy, comprising:
an active area, defined as a narrower region than the entire surface of the solar cell, capable of capturing solar light and converting it into electrical energy to generate current;
an exposed area, defined as the portion of the solar cell visible to an observer in an orthogonal direction of a solar panel;
wherein the active area is generally wider than the exposed area, enabling the active area to detect solar light broader than its designated coverage;
wherein, solar light can be captured by one of the sides of the solar cell, with the active area extending beyond the exposed area, even in the event of an error in the positioning angle of the solar panel.

10. A method for fabricating durable solar cells, the method comprising:
cutting a solar cell with thin busbars along its centerline to enable dual-sided utilization;
printing an additional busbar onto the solar cell surface to ensure continuous electrical contact, wherein said additional busbar is aligned with the centerline cut;
depositing a wider busbar atop the existing one through metal deposition techniques to increase load-carrying capacity; and
attaching thicker metallic busbars to each side of the solar cell to facilitate efficient current conduction.

11. The method of claim 10, wherein the printing of the additional busbar is performed using a silk-screen printing technique.
